(19) United States
(12) Patent Application Publication
(10) Pub. No.: US 2024/0166090 A1
(43) Pub. Date: May 23, 2024

(54) Method of Controlling Temperature of Battery for Vehicle

(71) Applicants: Hyundai Motor Company, Seoul (KR); Kia Corporation, Seoul (KR)

(72) Inventors: Jun Ho Bang, Anyang-si (KR); Sung Il Lee, Suwon-si (KR); Seok Won Kang, Seoul (KR)

(21) Appl. No.: 18/303,272

(22) Filed: Apr. 19, 2023

(30) Foreign Application Priority Data
Nov. 18, 2022 (KR) 10-2022-0155546

(51) Int. Cl. B60L 58/27; B60L 58/26; H01M 10/615; H01M 10/625; H01M 10/633; H01M 10/66

(52) U.S. Cl. CPC B60L 58/27; B60L 58/26; H01M 10/615; H01M 10/625; H01M 10/633; H01M 10/66

(57) ABSTRACT

An embodiment method includes determining whether a minimum temperature of a battery is equal to or less than a first temperature and whether an outside temperature is less than the minimum temperature, turning on a warming heater when the minimum temperature is equal to or less than the first temperature and the outside temperature is less than the minimum temperature, turning off the warming heater when a maximum temperature of the battery is equal to or higher than a predetermined second temperature higher than the first temperature and the minimum temperature of the battery is higher than the first temperature and exceeds a third temperature higher than the first temperature and lower than the second temperature, and turning off the warming heater when the maximum temperature exceeds a fourth temperature higher than the second temperature despite the minimum temperature being less than or equal to the third temperature.

### CROSS-REFERENCE TO RELATED APPLICATIONS

This application claims the benefit of Korean Patent Application No. 10-2022-0155546, filed on Nov. 18, 2022, which application is hereby incorporated herein by reference.

### TECHNICAL FIELD

The present disclosure relates to a method of controlling the temperature of a battery for a vehicle.

### BACKGROUND

In a hybrid vehicle or an electric vehicle, a battery is mounted to supply power to a motor that exerts a driving force of the vehicle.

The battery is often mounted in a vehicle in the form of a battery pack in which a plurality of battery modules are combined, and each battery module includes a plurality of battery cells.

In the battery described above, when the temperature of the battery cell is lowered in a low-temperature environment, the ionic conductivity of the electrolyte solution serving as a medium for transferring lithium ions between the positive electrode and the negative electrode inside the battery cell is lowered, resulting in an increase in internal resistance.

Therefore, due to the increase in the internal resistance of each battery cell in a low temperature situation, when charging current is applied, the time to reach the CUT-OFF voltage of a fully charged battery cell becomes faster at low temperature than at room temperature, so that the charging energy is reduced and the mileage of the vehicle on a single charge is reduced.

In addition, when a battery warming heater for raising the temperature of a battery operates excessively in a low-temperature situation, the temperature of the battery cell is maintained too high during charging, which may accelerate battery deterioration. Therefore, it is necessary to manage the temperature of the battery to be maintained at an appropriate level.

The foregoing explained as the background of the technology is intended merely to aid in the understanding of the background of embodiments of the present disclosure and is not intended to mean that the present disclosure falls within the purview of the related art that is already known to those skilled in the art.

### SUMMARY

Embodiments of the present disclosure provide a method of controlling the temperature of a battery for a vehicle, which is capable of appropriately controlling the temperature of the battery when charging the battery in a low-temperature environment to greatly increase the amount of electrical energy charged in the battery during charging of the battery, thereby greatly improving the mileage of a battery on a single charge.

According to one embodiment of the present disclosure, a method of controlling a temperature of a battery for a vehicle includes determining, by a controller, whether a minimum temperature of the battery is equal to or less than a predetermined first reference temperature and an outside temperature is less than the minimum temperature of the battery when charging of the battery starts, turning on a warming heater when the minimum temperature of the battery is equal to or less than the first reference temperature and the outside temperature is less than the minimum temperature of the battery, turning off, by the controller, the warming heater when a maximum temperature of the battery is equal to or higher than a predetermined second reference temperature higher than the first reference temperature, and the minimum temperature of the battery is higher than the first reference temperature and exceeds a predetermined third reference temperature higher than the first reference temperature and lower than the second reference temperature, and turning off, by the controller, the warming heater when the maximum temperature of the battery exceeds a predetermined fourth reference temperature higher than the second reference temperature even though the minimum temperature of the battery is less than or equal to the third reference temperature.

When the minimum temperature of the battery is less than or equal to the third reference temperature and the maximum temperature of the battery is higher than or equal to the second reference temperature and lower than or equal to the fourth reference temperature, the controller may turn on the warming heater or may maintain a turn-on state.

The method may further include turning off, by the controller, the warming heater when the maximum temperature of the battery is less than the second reference temperature and the minimum temperature of the battery exceeds a predetermined fifth reference temperature that is lower than the second reference temperature and higher than the third reference temperature.

When the maximum temperature of the battery is less than the second reference temperature and the minimum temperature of the battery is less than or equal to the fifth reference temperature, the controller may turn on the warming heater or maintain a turn-on state.

The method may further include turning on, by the controller, the warming heater when the minimum temperature of the battery is lowered to exceed a predetermined reference temperature difference compared to when the warming heater is turned off in a state where the warming heater is turned off.

According to another embodiment of the present disclosure, a method of controlling a temperature of a battery for a vehicle includes turning on, by a controller, a warming heater provided to increase the temperature of the battery when a minimum temperature of the battery is equal to or less than a predetermined first reference temperature and an outside temperature is less than the minimum temperature of the battery during charging of the battery and turning on the warming heater again when the minimum temperature of the battery is lowered to exceed a predetermined reference temperature difference compared to when the warming heater is turned off in a state where the controller turns off the warming heater according to a temperature change of the battery.

The method may further include turning off, by the controller, the warming heater when the maximum temperature of the battery is higher than or equal to a predetermined second reference temperature higher than the first reference temperature, and the minimum temperature of the battery exceeds a predetermined third reference temperature that is higher than the first reference temperature and lower than the second reference temperature after the warming heater is turned on.

The method may further include turning off, by the controller, the warming heater when the minimum temperature of the battery is lower than or equal to the third reference temperature and the maximum temperature of the battery exceeds a predetermined fourth reference temperature that is higher than the second reference temperature.

When the minimum temperature of the battery is less than or equal to the third reference temperature and the maximum temperature of the battery is higher than or equal to the second reference temperature and less than or equal to the fourth reference temperature, the controller may turn on the warming heater or maintain a turn-on state.

The method may further include turning off, by the controller, the warming heater when the maximum temperature of the battery is less than the second reference temperature and the minimum temperature of the battery exceeds a predetermined fifth reference temperature that is lower than the second reference temperature and higher than the third reference temperature.

When the maximum temperature of the battery is less than the second reference temperature and the minimum temperature of the battery is less than or equal to the fifth reference temperature, the controller may turn on the warming heater or maintain a turn-on state.

According to the embodiments of the present disclosure, when the battery is charged in a low-temperature environment, the temperature of the battery may be appropriately controlled to maximize the amount of electrical energy charged in the battery during charging of the battery, so that it is possible to greatly improve the mileage of a battery on a single charge.

### BRIEF DESCRIPTION OF THE DRAWINGS

The above and other objects, features, and other advantages of embodiments of the present disclosure will be more clearly understood from the following detailed description when taken in conjunction with the accompanying drawings, in which:

FIG. 1 is a diagram illustrating an example of the configuration of a system for controlling a temperature of a battery for a vehicle to which an embodiment of the present disclosure is applied;

FIG. 2 is a conceptual diagram illustrating the configuration of a vehicle to which a method of controlling a temperature of a battery for a vehicle according to an embodiment of the present disclosure can be applied; and

FIG. 3 is a flowchart illustrating a method of controlling a temperature of a battery for a vehicle according to an embodiment of the present disclosure.

### DETAILED DESCRIPTION OF ILLUSTRATIVE EMBODIMENTS

Hereinafter, embodiments disclosed in the present specification will be described in detail with reference to the accompanying drawings, and, regardless of the reference numerals, the same or corresponding configuration elements will be assigned with the same reference numeral and overlapping description of the same will be omitted for simplicity.

The suffixes “module” and “unit” (or “part”) that are mentioned in the elements used in the following description are merely used individually or in combination for the purpose of simplifying the description of embodiments of the present disclosure. Therefore, the suffix itself will not be used to give a significance or function that differentiates the corresponding terms from one another.

In addition, when explaining in detail an embodiment, the detailed description of the related known technologies will be omitted in order not to unnecessarily obscure the gist of the embodiments disclosed in the present specification. In addition, the features of the embodiments disclosed in the present specification will be more clearly understood from the accompanying drawings and should not be limited by the accompanying drawings. It is to be appreciated that the spirit and technical scope of embodiments of the present disclosure can encompass all changes, equivalents, and substitutes in addition to the attached drawings.

While terms including ordinal numbers, such as “first” and “second,” etc., may be used to describe various components, such components are not limited by the above terms. The above terms are used only to distinguish one component from another.

It will be understood that when an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

Singular forms are intended to include plural forms unless the context clearly indicates otherwise.

In embodiments of the present disclosure, terms such as “include” and/or “have” may be construed to denote a certain characteristic, number, step, operation, constituent element, component, or a combination thereof, but may not be construed to exclude the existence of or a possibility of addition of one or more other characteristics, numbers, steps, operations, constituent elements, components, or combinations thereof.

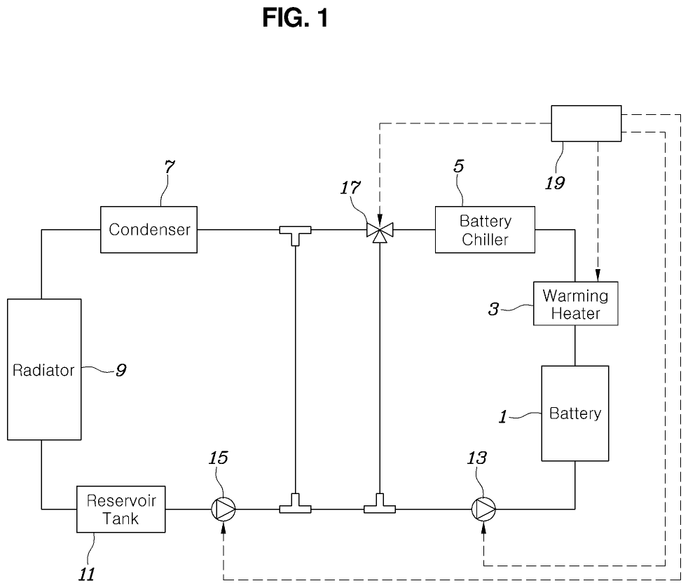

FIG. 1 is a diagram illustrating an example of a system for controlling a temperature of a battery for a vehicle to which an embodiment of the present disclosure is applied, where a battery 1 is installed to be able to exchange heat with cooling water, and the cooling water is circulated while passing through a warming heater 3, a battery chiller 5, a condenser 7, a radiator 9, a reservoir tank 11, a first pump 13, a second pump 15, and the like.

In addition, a 3-way valve 17 is provided to control the flow of the cooling water, and the first pump 13 and the second pump 15 are electrically configured. When the first pump 13, the second pump 15, and the 3-way valve 17 are controlled by a controller 19, the cooling water passes through the radiator 9 to cool the battery 1 while flowing through a path for cooling the battery 1. Alternatively, after the cooling water passes through the warming heater 3, the cooling water may flow through a path for heating the battery 1 without flowing into the radiator 9.

Hereinafter, it may be understood that when the controller 19 turns on the warming heater 3, the 3-way valve 17 is also controlled so that the cooling water passes through the warming heater 3 and is supplied to the battery 1 without passing through the radiator 9, thereby heating the battery 1.

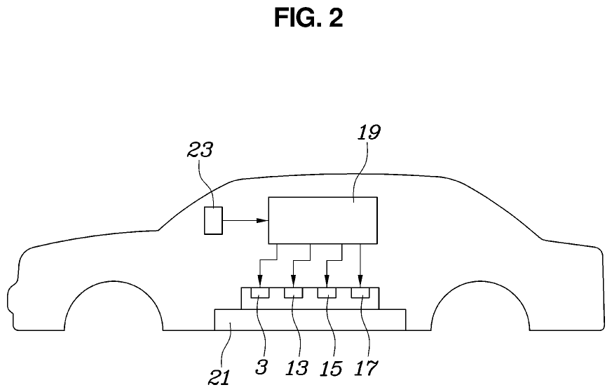

FIG. 2 is a conceptual diagram illustrating the configuration of a vehicle to which a method of controlling a temperature of a battery for a vehicle according to an embodiment of the present disclosure can be applied, where the controller 19 is connected to receive information on the outside temperature of the vehicle from a separate vehicle controller 23, and the controller 19 is configured to drive the 3-way valve 17 of a temperature control system connected to the battery pack 21, the warming heater 3, the first pump 13, and the second pump 15.

For reference, the controller 19 may be configured to obtain information on the outside temperature from a separate outside temperature sensor or the like.

In addition, it may be understood that the battery pack 21 corresponds to the battery 1 in FIG. 1.

That is, in embodiments of the present disclosure, ‘battery’ is used as a generic term for all battery cells inside a battery pack, and ‘battery cell’ is used to express individual battery cells.

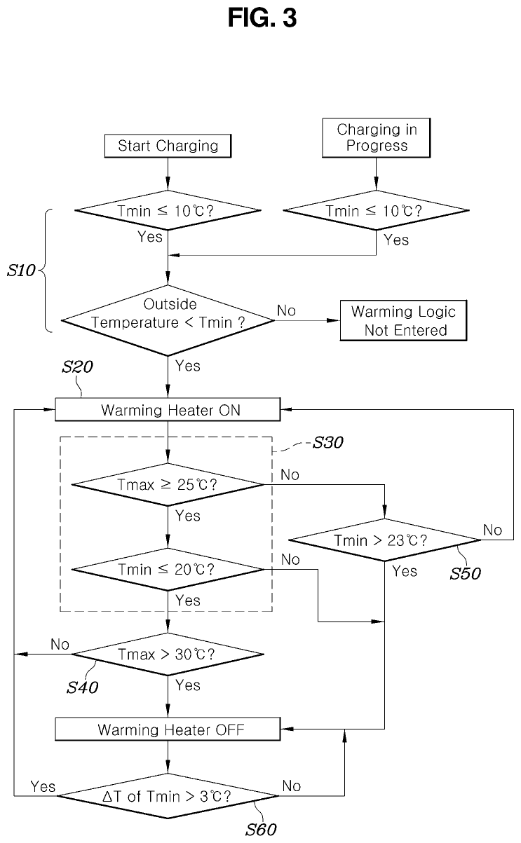

Referring to FIG. 3, according to an embodiment of the present disclosure, a method of controlling a temperature of a battery for a vehicle includes an operation S10 of determining, by the controller 19, whether the minimum temperature Tmin of the battery is less than or equal to a predetermined first reference temperature and the outside temperature is less than the minimum temperature Tmin of the battery when the battery starts charging, an operation S20 of turning on the warming heater 3 when the minimum temperature (Tmin) of the battery is less than or equal to the first reference temperature and the outside temperature is less than the minimum temperature Tmin of the battery, an operation S30 of turning off, by the controller 19, the warming heater 3 when the maximum temperature Tmax of the battery is higher than or equal to a predetermined second reference temperature higher than the first reference temperature, and the minimum temperature Tmin of the battery exceeds a predetermined third reference temperature that is higher than the first reference temperature and lower than the second reference temperature, and an operation S40 of turning off, by the controller 19, the warming heater 3 when the minimum temperature Tmin of the battery is equal to or less than the third reference temperature and the maximum temperature Tmax of the battery exceeds a predetermined fourth reference temperature higher than the second reference temperature.

That is, when the outside temperature at the location where the vehicle is located is less than the minimum temperature Tmin of the battery and the minimum temperature Tmin of the battery is less than or equal to the first reference temperature when the battery is charged, the controller 19 turns on the warming heater 3 and drives the first pump 13 to directly supply the cooling water heated by the warming heater 3 to the battery pack 21 without passing through the radiator 9, thereby increasing the temperature of the battery cells. Accordingly, by preventing the internal resistance of the battery cells from increasing, the amount of electrical energy charged in the battery reaches a level similar to that of the room temperature state.

Therefore, as described above, according to embodiments of the present disclosure, even when the area where the vehicle is charged is in an extreme region, the amount of electric energy charged in the battery is almost similar to that in a case where the battery is charged at room temperature, so that the mileage of the vehicle on a single charge may be relatively increased.

For reference, it may be understood that the minimum temperature Tmin and the maximum temperature Tmax of the battery mean the minimum temperature Tmin and the maximum temperature Tmax among the temperatures collected from a plurality of temperature sensors installed to measure the temperatures of battery cells in the battery pack 21 mounted on the vehicle as shown in FIG. 2.

In addition, since the first reference temperature is set at a level capable of determining whether to operate the warming heater 3 for proper charging of the battery, the first reference temperature may be determined by design through a number of experiments and analyses. In the present embodiment, the first reference temperature is set to, for example, 10° C.

When it is determined that the battery as a whole is in the normal temperature range because the maximum temperature Tmax of the battery is equal to or higher than the second reference temperature and the minimum temperature Tmin of the battery exceeds the third reference temperature, as described above, the controller 19 turns off the warming heater 3 to prevent the battery from being excessively heated.

Accordingly, the second reference temperature and the third reference temperature may be set to appropriate values by design through a number of experiments and analyses to represent the room temperature range.

In the present embodiment, for example, the second reference temperature is set to 25° C., and the third reference temperature is set to 20° C.

Meanwhile, as described above, when the maximum temperature Tmax of the battery exceeds the fourth reference temperature, even though the minimum temperature Tmin of the battery is equal to or less than the third reference temperature, the controller 19 turns off the warming heater 3 to prevent the temperature of the battery from excessively rising.

Therefore, the fourth reference temperature may be set to a level at which the temperature of the battery may be determined to be excessive beyond an appropriate level, and may be determined by design through a number of experiments and analyses.

For reference, in the present embodiment, the fourth reference temperature is set to, for example, 30° C.

In this case, when the minimum temperature Tmin of the battery is less than or equal to the third reference temperature and the maximum temperature Tmax of the battery is higher than or equal to the second reference temperature but less than or equal to the fourth reference temperature, the controller 19 turns on the warming heater 3 or maintains the turn-on state.

Meanwhile, according to an embodiment, the method may further include an operation S50 of turning off, by the controller 19, the warming heater 3 when the maximum temperature Tmax of the battery is less than the second reference temperature and the minimum temperature Tmin of the battery exceeds a predetermined fifth reference temperature lower than the second reference temperature and higher than the third reference temperature.

That is, in this case, because it may be understood that all the battery cells in the battery pack 21 have an almost uniform temperature distribution at room temperature, there is no need to heat the battery anymore, so the warming heater 3 is turned off.

In this case, as described above, the fifth reference temperature may be set together with the second reference temperature to grasp the temperature condition of the battery cells in an almost uniform room temperature state, and can be determined by design through a number of experiments and analyses. In the present embodiment, the fifth reference temperature is set to, for example, 23° C.

Of course, when the maximum temperature Tmax of the battery is less than the second reference temperature and the minimum temperature Tmin of the battery is less than or equal to the fifth reference temperature, the controller 19 turns on the warming heater 3 or maintains the turn-on state.

Meanwhile, through the above steps, in a state where the warming heater 3 is turned off, when the minimum temperature Tmin of the battery is lowered to exceed a predetermined reference temperature difference compared to when the warming heater 3 is turned off, the method may further include an operation S60 of turning on, by the controller 19, the warming heater 3.

That is, even though it is determined that the battery is sufficiently heated by turning on the warming heater 3 and the warming heater 3 is turned off, after the warming heater 3 is turned off, when the minimum temperature Tmin of the battery is lowered to exceed the reference temperature difference compared to when the warming heater 3 is turned off so that it is determined that the batteries are cooled a lot by far enough to exceed the reference temperature difference, the warming heater 3 is turned on again to heat the batteries.

This is to prepare a case where, in an extreme region where the vehicle is located, the temperature of the battery heated to a certain level or more starts to be lowered during charging of the battery as soon as the warming heater 3 is turned off, so that the temperature is lowered to exceed the reference temperature difference before charging is completed. By the control described above, the battery charging of an electric vehicle or the like may be performed very effectively even in an extreme region such as a cold region.

In this case, the reference temperature difference is preferably determined by design through a number of experiments and analyses according to the above-mentioned purpose, and in this embodiment, the reference temperature difference is set to, for example, 3° C.

Therefore, according to an embodiment, when the minimum temperature Tmin of the battery is 20° C. when the warming heater 3 is turned off and the minimum temperature Tmin of the battery is less than 17° C. after the warming heater 3 is turned off, the warming heater 3 is turned on again.

The embodiments of the present disclosure as described above may be expressed as follows.

That is, according to an embodiment of the present disclosure, a method of controlling a temperature of a battery for a vehicle includes an operation S20 of turning on, by the controller 19, the warming heater 3 provided to increase the temperature of the battery when the minimum temperature Tmin of the battery is equal to or less than a predetermined first reference temperature and the outside temperature is less than the minimum temperature Tmin of the battery when the battery is charged and an operation S60 of turning on, by the controller 19, the warming heater 3 again when, in a state where the controller 19 turns off the warming heater 3 according to the temperature change of the battery, the minimum temperature Tmin of the battery is lowered to exceed a predetermined reference temperature difference compared to when the warming heater 3 is turned off.

The method may further include an operation S30 of turning off, by the controller 19, the warming heater 3 when the maximum temperature Tmax of the battery is higher than or equal to a predetermined second reference temperature higher than the first reference temperature, and the minimum temperature Tmin of the battery exceeds a predetermined third reference temperature that is higher than the first reference temperature and lower than the second reference temperature after the warming heater 3 is turned on.

In addition, the method may further include an operation S40 of turning off, by the controller 19, the warming heater 3 when the maximum temperature Tmax of the battery exceeds a predetermined fourth reference temperature higher than the second reference temperature even though the minimum temperature Tmin of the battery is less than or equal to the third reference temperature.

When the minimum temperature Tmin of the battery is less than or equal to the third reference temperature and the maximum temperature Tmax of the battery is higher than or equal to the second reference temperature but less than or equal to the fourth reference temperature, the controller 19 may turn on the warming heater 3 or maintain the turn-on state.

The method may further include an operation S50 of turning off, by the controller 19, the warming heater 3 when the maximum temperature Tmax of the battery is less than the second reference temperature and the minimum temperature Tmin of the battery exceeds a predetermined fifth reference temperature lower than the second reference temperature and higher than the third reference temperature.

When the maximum temperature Tmax of the battery is less than the second reference temperature and the minimum temperature Tmin of the battery is less than or equal to the fifth reference temperature, the controller 19 may turn on the warming heater 3 or maintain a turn-on state.

For reference, FIG. 3 illustrates that embodiments of the present disclosure may be performed when the charging of the battery starts or may be performed during charging of the battery as described above.

Although specific embodiments of the present disclosure have been described and illustrated, those skilled in the art will appreciate that various alternations and modifications are possible without departing from the technical spirit of the present disclosure as disclosed in the appended claims.

What is claimed is:

1. A method of controlling a temperature of a battery for a vehicle, the method comprising:
determining whether a minimum temperature of the battery is equal to or less than a predetermined first reference temperature and whether an outside temperature is less than the minimum temperature of the battery at a start of battery charging;
turning on a warming heater in response to a determination that the minimum temperature of the battery is equal to or less than the first reference temperature and the outside temperature is less than the minimum temperature of the battery;
turning off the warming heater in response to a maximum temperature of the battery being equal to or higher than a predetermined second reference temperature higher than the first reference temperature and the minimum temperature of the battery being higher than the first reference temperature and exceeding a predetermined third reference temperature higher than the first reference temperature and lower than the second reference temperature; and
turning off the warming heater in response to the maximum temperature of the battery exceeding a predetermined fourth reference temperature higher than the second reference temperature despite the minimum temperature of the battery being less than or equal to the third reference temperature.

2. The method of claim 1, wherein, in response to the minimum temperature of the battery being less than or equal to the third reference temperature and the maximum temperature of the battery being higher than or equal to the second reference temperature and less than or equal to the fourth reference temperature, the method further comprises turning on the warming heater.

3. The method of claim 1, wherein, in response to the minimum temperature of the battery being less than or equal to the third reference temperature and the maximum temperature of the battery being higher than or equal to the second reference temperature and less than or equal to the fourth reference temperature, the method further comprises maintaining a turn-on state.

4. The method of claim 1, further comprising turning off the warming heater in response to the maximum temperature of the battery being less than the second reference temperature and the minimum temperature of the battery exceeding a predetermined fifth reference temperature that is lower than the second reference temperature and higher than the third reference temperature.

5. The method of claim 4, wherein, in response to the maximum temperature of the battery being less than the second reference temperature and the minimum temperature of the battery being less than or equal to the fifth reference temperature, the method further comprises turning on the warming heater.

6. The method of claim 4, wherein, in response to the maximum temperature of the battery being less than the second reference temperature and the minimum temperature of the battery being less than or equal to the fifth reference temperature, the method further comprises maintaining a turn-on state.

7. The method of claim 1, further comprising turning on the warming heater in response to the minimum temperature of the battery being lowered to exceed a predetermined reference temperature difference compared to when the warming heater is turned off in a state where the warming heater is turned off.

8. A method of controlling a temperature of a battery for a vehicle, the method comprising:
turning on a warming heater provided to increase the temperature of the battery in response to a minimum temperature of the battery being equal to or less than a predetermined first reference temperature and an outside temperature being less than the minimum temperature of the battery during charging of the battery; and
turning on the warming heater again in response to the minimum temperature of the battery being lowered to exceed a predetermined reference temperature difference compared to a state in which the warming heater is turned off according to a temperature change of the battery.

9. The method of claim 8, further comprising turning off the warming heater in response to a maximum temperature of the battery being higher than or equal to a predetermined second reference temperature that is higher than the first reference temperature and the minimum temperature of the battery exceeding a predetermined third reference temperature that is higher than the first reference temperature and less than the second reference temperature after the warming heater is turned on.

10. The method of claim 9, further comprising turning off the warming heater in response to the minimum temperature of the battery being less than or equal to the third reference temperature and the maximum temperature of the battery exceeding a predetermined fourth reference temperature that is higher than the second reference temperature.

11. The method of claim 10, wherein, in response to the minimum temperature of the battery being less than or equal to the third reference temperature and the maximum temperature of the battery being higher than or equal to the second reference temperature and less than or equal to the fourth reference temperature, the method further comprises turning on the warming heater.

12. The method of claim 10, wherein, in response to the minimum temperature of the battery being less than or equal to the third reference temperature and the maximum temperature of the battery being higher than or equal to the second reference temperature and less than or equal to the fourth reference temperature, the method further comprises maintaining a turn-on state.

13. The method of claim 10, further comprising turning off the warming heater in response to the maximum temperature of the battery being less than the second reference temperature and the minimum temperature of the battery exceeding a predetermined fifth reference temperature that is lower than the second reference temperature and higher than the third reference temperature.

14. The method of claim 13, wherein, in response to the maximum temperature of the battery being less than the second reference temperature and the minimum temperature of the battery being less than or equal to the fifth reference temperature, the method further comprises turning on the warming heater.

15. The method of claim 13, wherein, in response to the maximum temperature of the battery being less than the second reference temperature and the minimum temperature of the battery being less than or equal to the fifth reference temperature, the method further comprises maintaining a turn-on state.

16. A system for controlling a temperature of a battery of a vehicle, the system comprising:
the battery configured to exchange heat with cooling water;
a warming heater configured to warm the cooling water to heat the battery;
a radiator configured to cool the cooling water to cool the battery; and
a controller configured to:
determine whether a minimum temperature of the battery is equal to or less than a predetermined first reference temperature and whether an outside temperature is less than the minimum temperature of the battery at a start of battery charging;
turn on the warming heater in response to a determination that the minimum temperature of the battery is equal to or less than the first reference temperature and the outside temperature is less than the minimum temperature of the battery;
turn off the warming heater in response to a maximum temperature of the battery being equal to or higher than a predetermined second reference temperature higher than the first reference temperature and the minimum temperature of the battery being higher than the first reference temperature and exceeding a predetermined third reference temperature higher than the first reference temperature and lower than the second reference temperature; and
turn off the warming heater in response to the maximum temperature of the battery exceeding a predetermined fourth reference temperature higher than the second reference temperature despite the minimum temperature of the battery being less than or equal to the third reference temperature.

17. The system of claim 16, wherein, in response to the minimum temperature of the battery being less than or equal to the third reference temperature and the maximum temperature of the battery being higher than or equal to the second reference temperature and less than or equal to the fourth reference temperature, the controller is configured to turn on the warming heater or maintain a turn-on state.

18. The system of claim 16, wherein the controller is configured to turn off the warming heater in response to the maximum temperature of the battery being less than the second reference temperature and the minimum temperature of the battery exceeding a predetermined fifth reference temperature that is lower than the second reference temperature and higher than the third reference temperature.

19. The system of claim 18, wherein, in response to the maximum temperature of the battery being less than the second reference temperature and the minimum temperature of the battery being less than or equal to the fifth reference temperature, the controller is configured to turn on the warming heater or maintain a turn-on state.

20. The system of claim 19, wherein the controller is configured to turn on the warming heater in response to the minimum temperature of the battery being lowered to exceed a predetermined reference temperature difference compared to when the warming heater is turned off in a state where the warming heater is turned off.
